(19) United States
(12) Patent Application Publication
(10) Pub. No.: US 2025/0051130 A1
(43) Pub. Date: Feb. 13, 2025

(54) METHOD FOR DETERMINING A LEAD TORQUE OF AN ELEVATOR SYSTEM

(71) Applicant: Inventio AG, Hergiswil (CH)

(72) Inventor: Thomas Eilinger, Kussnacht am Rigi (CH)

(21) Appl. No.: 18/716,966

(22) PCT Filed: Dec. 13, 2022
(86) PCT No.: PCT/EP2022/085514

§ 371 Date: Jun. 6, 2024

(30) Foreign Application Priority Data
Dec. 13, 2021 (EP) 21213947.1

(51) Int. Cl. B66B 1/30; B66B 1/34

(52) U.S. Cl. CPC B66B 1/304; B66B 1/3476; B66B 1/3492

(57) ABSTRACT

A method for determining a lead torque of an elevator system involves: generating control commands controlling an electric motor so that an elevator car coupled to a counterweight performs at least first through fourth test runs, wherein the car is moved from a first to a second position and back in successive runs and is loaded in the third and fourth runs with a weight; during movement of the car receiving current measurement data of current flowing through the motor and height measurement data indicating a height of the car; calculating at least one parameter of a calibration function defining a relationship between the current, the height, and the weight using the measurement data to obtain at least one calibration value; and calculating an adaptation value wherein the counterweight is adapted to be in equilibrium with the car using the at least one calibration value.

### FIELD

The present invention relates to a method for determining a lead torque of an elevator system. Furthermore, the invention relates to a control device, a computer program and to a computer-readable medium for carrying out such a method. The invention also relates to an elevator system equipped with such a control device.

### BACKGROUND

An elevator system, such as a passenger or freight elevator, generally comprises a counterweight, which is connected to an elevator car via suitable suspension means and serves to reduce the forces required for raising or lowering the elevator car.

The counterweight and the elevator car should be in equilibrium with one another when the elevator car is loaded with a certain weight. In order to produce this state of equilibrium, weight can be progressively added to or removed from the loaded elevator car, for example, by means of compensating weights until it is in equilibrium with the counterweight, i.e., it no longer moves when the elevator car brake is released. The counterweight can then be adapted according to the compensating weights that are added or removed. Such a step-by-step approach to the correct counterweight can be very time-consuming. In addition, the result can be imprecise due to different frictional conditions when raising and lowering the elevator car. The actual state of equilibrium has an influence on the lead torque. In order to achieve a high quality of travel, it must be taken into account when determining the lead torque.

### SUMMARY

There can therefore be a need for a simplified method for determining a lead torque in which the actually present state of equilibrium is taken into account. Furthermore, there may be a need for a control device, a computer program product, and a computer-readable medium for performing such a method as well as for an elevator system equipped with such a control device.

Such a need can be met by the subject matter of any of the advantageous embodiments defined in the following description.

A first aspect of the invention relates to a method for determining a lead torque. The elevator system comprises an elevator shaft, an elevator car, which is movable along the elevator shaft at least between a first position and a second position and is coupled to the counterweight via suspension means, and an electric motor for driving the elevator car. The method comprises at least the following steps: generating control commands for actuating the electric motor so that the elevator car carries out at least a first, second, third, and fourth test run, wherein the elevator car in the first and third test run is respectively moved from the first position into the second position, and in the second and fourth test run from the second position into the first position, wherein the elevator car is loaded with a weight in the third and fourth test run and is not loaded with the weight in the first and second test runs; receiving current measurement data, which indicate a current that flows through the electric motor measured by means of a current measurement device while moving the elevator car, and height measurement data that indicates a height of the elevator car relative to the first and/or second position measured by means of a height measurement device while moving the car, in a plurality of successive time steps in each test run; calculating at least one parameter of a calibration function that defines a relationship between the current, the height, and the weight using the current measurement data and the height measurement data that was received in different test runs to obtain at least one calibration value; calculating a first weight difference that is representative of a weight difference between the mass of the elevator system on one side of the traction sheave of the electric motor and the mass of the elevator system on the other side of the traction sheave when the elevator car is in the first position; calculating a second weight difference that is representative of a weight difference between the mass of the elevator system on one side of the traction sheave of the electric motor and the mass of the elevator equipment on the other side of the traction sheave when the elevator car is at the second position, wherein the first weight difference and the second weight difference are calculated using the calibration function and the at least one calibration value; and determining a lead torque for applying to the electric motor before the car is moved in response to the first and second weight differences.

The method can, for example, be automatically carried out by a processor of the control device of the elevator system.

The first and second positions can be positions of different height of the elevator car in the elevator shaft. For example, the first position can be the highest position of the elevator car and the second position can be the lowest position of the elevator car, or vice versa.

For calculating the at least one parameter of the calibration function, for example, only those current measurement data and/or only those height measurement data can be used that were generated and/or received in a period of time in which the speed of the elevator car is detected as being constant. This can be the case, for example, when it is detected by evaluating the height measurement data, for example, that the elevator car moves within a specific height range between the first and second positions.

The electric motor can, for example, be controlled in such a way that the elevator car is moved in each test run corresponding to a predefined speed profile without an intermediate stop either from the first to the second position, or from the second to the first position. The speed profile may comprise, for example, a continuously increasing portion, a constant portion, and a continuously decreasing portion. In this case, the constant portion can, on the one hand, transition directly into the continuously increasing portion and, on the other hand, directly into the continuously decreasing portion.

It is possible for the current measuring device to generate the current measurement data in a plurality of successive time steps in each test run and transmit it to the control device. It is also possible for the height measuring device to generate the height measurement data in a plurality of successive time steps in each test run and transmit it to the control device. In this case, the current measurement data and the height measurement data can be temporally correlated to one another. For example, the same time stamp can be assigned to the current measurement data and the height measurement data, which are temporally correlated to one another.

The current measuring device can be, for example, a component of a current regulator for regulating a current flow through the electric motor. In this case, the controller can be configured to control circuit breakers of a converter, which is connected at its output to terminals of the electric motor, using the current measurement data.

The height measuring device can comprise, for example, a position sensor in the form of an absolute encoder or incremental encoder. Additionally or alternatively, the height measuring device may comprise a barometer. Alternatively or in addition to such a direct measurement, the height of the elevator car can also be determined from an acceleration of the elevator car, a rotational speed, or an angle of rotation of the electric motor.

“Calibration function” can be understood to mean a mathematical function, for example a linear function, or else a polynomial of second or higher degree. The parameter or parameters of the calibration function can be calculated, for example, by processing the current measurement data and the height measurement data in a regression method. The current measurement data and the height measurement data generated and/or received in all four test runs can be processed. As already mentioned, only those current measurement data and/or only those height measurement data of each test run can be processed that were generated and/or received within a certain period of time during the respective test runs in which the speed of the elevator car was detected as being constant.

The current may, for example, be a dependent variable of the calibration function, wherein the height and the weight can be independent variables of the calibration function.

“Current” may also be understood to mean a current component, for example a d or q component of the current.

“Calibration value” may be understood to mean a parameter value assigned to a single parameter of the calibration function.

The “weight difference” (also referred to as “unbalance” and expressed in the unit [kg]) relates to an imbalance present in the elevator system relative to the center point formed by the traction sheave. In other words, the weight difference is the difference between the weight of the elevator system (for example first subsection of the suspension means plus counterweight) on the one side of the traction sheave and the weight of the elevator system (overall suspension means minus the first subsection of the suspension means plus elevator car) on the other side of the traction sheave. For example, when the elevator car is located at the uppermost floor (first position), the suspension means can be almost exclusively on the counterweight side of the traction sheave. In this case, the amount of the weight difference results from the difference in the weight of the counterweight plus almost the total weight of the suspension means minus the weight of the elevator car.

The “first weight difference” (unbalance_top) corresponds to the above-mentioned weight difference in the first position (that is, when the car is located at the uppermost floor). The “second weight difference” (unbalance_bot) corresponds to the above-mentioned weight difference in the second position (that is, when the car is located at the lowest floor).

The “lead torque” denotes the torque at which the electric motor of the elevator system has to be acted upon in order for the elevator car to remain in the holding position after the brake has been released. The purpose of applying the lead torque to the electric motor is to prevent the elevator car from moving upwards or downwards after the brake has been released. This is decisive in particular for the ride quality. The more precisely the lead torque can be determined, the better the ride quality.

In brief, the method described here and below enables a significantly simpler and more accurate determination, compared to conventional methods, of the correct lead torque. By precisely determining the lead torque, unwanted movements of the elevator car when the car brake is released can be avoided.

In this case, measurement inaccuracies due to friction fluctuations can be minimized. This can be achieved, for example, by averaging measurement results from measurements that are taken during a phase in which the elevator car is traveling at an (approximately) constant speed in a suitable manner, thereby effectively filtering out measurement noise and measurement deviations due to friction fluctuations as a function of the travel path.

A second aspect of the invention relates to a control device having a processor, which is configured to carry out the method according to one embodiment of the first aspect of the invention. The control device may comprise hardware and/or software modules. In addition to the processor, the control device may comprise a memory and data communication interfaces for data communication with peripheral devices. Features of the method according to one embodiment of the first aspect of the invention may also be features of the control device, and vice versa.

A third aspect of the invention relates to an elevator system, for example a freight or passenger elevator. The elevator system comprises an elevator shaft, an elevator car, which is movable along the elevator shaft at least between a first position and a second position, a counterweight, which is coupled to the elevator car via suspension means, an electric motor for driving the elevator car, a current measuring device for measuring a current flowing through the electric motor, a height measuring device for measuring a height of the elevator car relating to the first and/or second position, and a control device according to one embodiment of the second aspect of the invention.

A fourth aspect of the invention relates to a computer program, which comprises commands that prompt a processor to carry out the method according to one embodiment of the first aspect of the invention when the computer program is executed by the processor.

A fifth aspect of the invention relates to a computer-readable medium on which the computer program according to one embodiment of the fourth aspect of the invention is stored. The computer-readable medium can be a volatile or non-volatile data memory. For example, the computer-readable medium may be a hard disk, a USB memory device, a RAM, ROM, EPROM, or flash memory. The computer-readable medium can also be a data communication network that enables a program code to be downloaded, such as the Internet or a data cloud.

Features of the method according to an embodiment of the first aspect of the invention can also be features of the computer program and/or of the computer-readable medium, and vice versa.

Possible features and advantages of embodiments of the invention can be regarded, inter alia and without limiting the invention, as being based upon the concepts and findings described below.

According to one embodiment, a height reference value can be calculated by halving a height difference between the first and second position. Additionally or alternatively, a weight reference value can be calculated by multiplying a permissible mass of the weight by a predetermined weighting factor. In this case, the lead torque may further be calculated using the height reference value, the weight reference value, or a combination of the height reference value and the weight reference value.

The height difference may, for example, have been measured in a programming run of the elevator car preceding the method. The height difference may correspond to an actual length of a distance that the elevator car can travel when moving from the first position to the second position, or vice versa. In the balanced state, the elevator car and the counterweight should remain at the same height, i.e. at half the height between the first and second positions, when the elevator car brake is released. The weighting factor can indicate a predetermined ratio of the counterweight to the nominal load, i.e. to the permissible mass of the weight, in the balanced state.

According to one embodiment, a first average function defining a first relationship between the current and the height, while assuming ideal friction conditions, can be determined using the current measurement data and the height measurement data that were received in the first and second test runs. Additionally or alternatively, a second average function defining a second relationship between the current and the height, while assuming ideal friction conditions, may be determined using the current measurement data and the height measurement data received in the third and fourth test runs. In this case, the at least one parameter of the calibration function may be calculated using the first average function and/or the second average function. The term “ideal friction conditions” can be understood to mean identical frictional conditions when the elevator car moves in both directions. The first average function and/or the second average function can be, for example, a linear function and/or a function obtained by linear regression. In this way, the parameter or parameters of the calibration function can be calculated with little computing effort.

According to one embodiment, an output function that defines a linear relationship between the current and the height may be determined for each test run by processing the current measurement data and the height measurement data received in different time steps in the relevant test run. In this case, at least one parameter of the first average function may be calculated by forming a mean value from a parameter of the output function for the first test run and a parameter of the output function for the second test run. Additionally or alternatively, at least one parameter of the second average function may be calculated by forming a mean value from a parameter of the output function for the third test run and a parameter of the output function for the fourth test run. In this way, the computing effort involved in calculating the parameter or parameters of the calibration function can be further reduced.

The output function can, for example, comprise at least one first parameter and one second parameter.

In this case, it is possible for a first parameter of the first average function to be determined by forming a mean value from the first parameter of the output function for the first test run and the first parameter of the output function for the second test run. Similarly, a second parameter of the first average function may be determined by forming a mean value from the second parameter of the output function for the first test run and the second parameter of the output function for the second test run.

Additionally or alternatively, it is possible in this case for a first parameter of the second average function to be determined by forming a mean value from the first parameter of the output function for the third test run and the first parameter of the output function for the fourth test run. Similarly, a second parameter of the second average function may be determined by forming a mean value from the second parameter of the output function for the third test run and the second parameter of the output function for the fourth test run.

According to one embodiment, a first current value may be calculated by inputting the height reference value into the first average function. In addition or alternatively, a second current value may be calculated by inputting the height reference value into the second average function. In this case, the at least one parameter of the calibration function may be calculated using the first and/or second current value. In this context, “current value” can be understood as an ideal value for the current flowing through the electric motor, or for a component of this current, e.g., a d or q component, while assuming ideal friction conditions during the movement of the elevator car.

According to one embodiment, a height-related parameter of the calibration function may be calculated to obtain a height calibration value as the calibration value. Additionally or alternatively, a weight-related parameter of the calibration function may be calculated to obtain a weight calibration value as the calibration value. Additionally or alternatively, a current-related parameter of the calibration function may be calculated to obtain a current calibration value as the calibration value. For example, the height calibration value can have the unit [A/m], the weight calibration value can have the unit [A/kg] and the current calibration value can have the unit [A]. However, other suitable units are also possible. In other words, the lead torque may be calculated using the height calibration value, the weight calibration value, the current calibration value, or a combination of at least two of the calibration values. In this way, the lead torque can be calculated very precisely without the elevator car having to be loaded with different weights.

According to one embodiment, the height calibration value may be obtained by forming a mean value from a height-related parameter of the first average function and a height-related parameter of the second average function. In this way, the computing effort required when calculating the height calibration value can be further reduced.

According to one embodiment, the weight calibration value may be obtained by dividing a difference between the first current value and the second current value by a weight value indicating the current mass of the weight. Additionally or alternatively, the current calibration value may be obtained by subtracting a product of the height calibration value and the height reference value from the first current value. Alternatively or additionally, when determining the current calibration value, the product can be subtracted from the weight calibration value multiplied by the mass of the actual weight at the first test run (GQT_test1). The current mass of the weight may be, for example, equal to a nominal mass of the counterweight or equal to a product of a permissible mass of the weight and a predetermined weighting factor. In this way, the computing effort required when calculating the weight calibration value or the current calibration value can be further reduced.

According to one embodiment, a check can be made in each time step to see whether the elevator car is moving at a constant speed. In this case, for calculating the at least one parameter of the calibration function, only the current measurement data and/or only the height measurement data from the time steps in which the elevator car is identified as moving at a constant speed can be used. The constant speed of the elevator car can be identified by comparing the speed of the elevator car in a current time step with the speed of the elevator car in at least one time step preceding the current time step. It is also possible for the speed of the elevator car to be identified as being constant when it is identified that the elevator car is moving within a certain height range between the first and second positions. This height range may have been calculated, for example, from known movement parameters of the elevator car, while taking into account the known height difference between the first and second positions, i.e. a simple distance between the first position and the second position. Whether or not the elevator car is in this height range may be identified, for example, by appropriately evaluating the height measurement data. In this way, inaccuracies in the calculation of the lead torque due to excessive speed changes can be avoided.

According to one embodiment, the height calibration value may be multiplied by the height reference value, the resulting product is added to the current calibration value, and the resulting sum is divided by the weight calibration value and the permissible mass of the weight to obtain a negative actual equilibrium factor. In this way, the computing effort required when calculating the lead torque can be further reduced.

According to one embodiment, the first and/or the second weight difference is determined on the basis of the calibration function and the weight calibration value. The first weight difference is determined in particular from the negative height calibration value divided by the weight calibration value and multiplied by the height reference value. The second weight difference is determined in particular from the height calibration value divided by the weight calibration value multiplied by the height reference value. In this way, the computing effort required when calculating the lead torque can be further reduced.

According to one embodiment, the lead torque is determined proportionally to the sum of the second weight difference, the current mass of the weight in the car, the negative actual equilibrium factor multiplied by the permissible mass of the weight, and the measured height divided by the height difference between the first position and the second position multiplied by the difference between the first weight difference minus the second weight difference. In this way, the computing effort required when calculating the lead torque can be further reduced.

For example, it is possible for the first average function to be newly determined using additional current measurement data and additional height measurement data to obtain an updated first average function. In this case, the current calibration value can be recalculated using the updated first average function to obtain an updated current calibration value. The lead torque can then be recalculated using the updated current calibration value together with the height calibration value and the weight calibration value.

Embodiments of the invention will be described below with reference to the accompanying drawings, wherein neither the drawings nor the description are intended to be interpreted as limiting the invention.

### DESCRIPTION OF THE DRAWINGS

FIG. 1 shows an elevator system according to one embodiment of the invention.

FIG. 2 shows a control device according to one embodiment of the invention.

FIG. 3 is a diagram illustrating various current and speed profiles, which were measured or calculated during the control of the elevator system from FIG. 1.

FIG. 4 shows a flow chart for a method according to one embodiment of the invention.

The drawings are merely schematic, and not to scale. In the different figures, identical reference signs denote identical or similar features.

### DETAILED DESCRIPTION

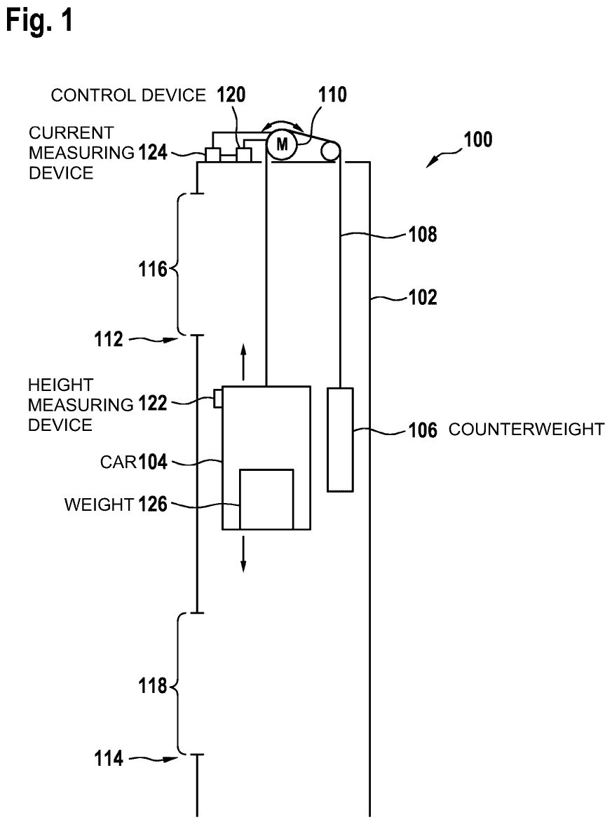

FIG. 1 shows an elevator system 100, for example a passenger or freight elevator in a building, which comprises an elevator shaft 102, an elevator car 104, a counterweight 106, which is coupled to the elevator car 104 via suspension means 108, for example via one or more cables, straps, or belts, and an electric motor with a traction sheave 110 for driving the suspension means 108, and thus the elevator car 104 or counterweight 106.

The elevator car 104 is moveable along the elevator shaft 102 between a first position 112 and a second position 114. By way of example, in FIG. 1 the first position 112 is a stopping point of the elevator car 104 relative to a first shaft opening 116 in an uppermost story of the building, and the second position 114 is a stopping point of the elevator car 104 relative to a second shaft opening 118 in a lowermost story of the building. Further stopping points of the elevator car 104 can be provided between the two positions 112, 114.

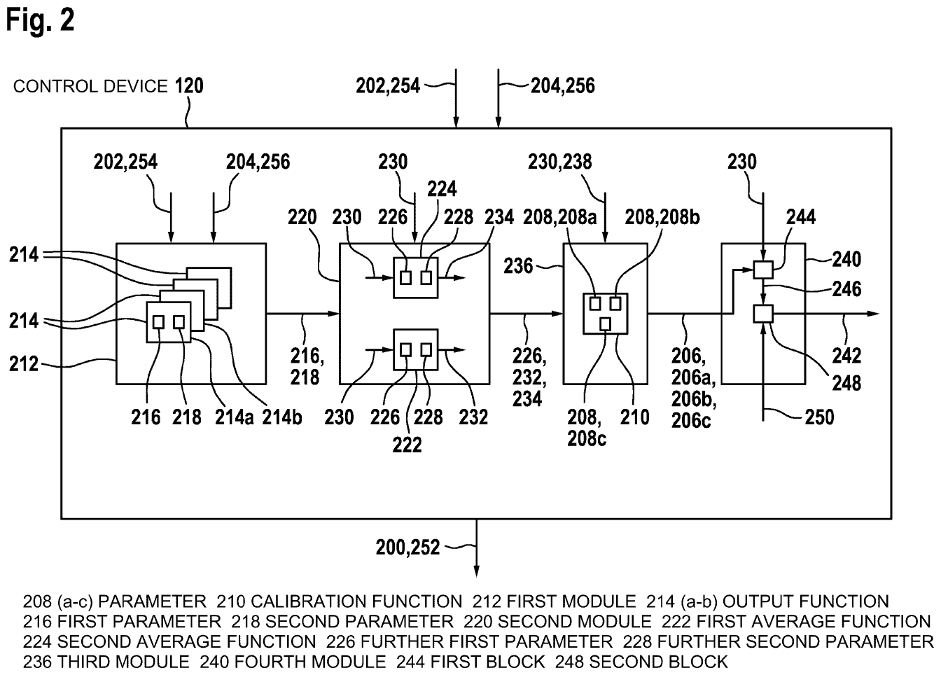

Furthermore, the elevator system 100 comprises a control device 120 for controlling the electric motor 110, as is described in more detail below with reference to FIG. 2.

An input of the control device 120 is connected to an output of a height measuring device 122 that is configured to measure the current height of the elevator car 104 in the elevator shaft 102 relative to the first position 112 and/or to the second position 114. By way of example, the height measuring device 122 in FIG. 1 is configured as an absolute encoder for measuring an absolute position of the elevator car 104 in the elevator shaft 102. However, it is also possible for it to be designed as an incremental encoder or barometer.

The input of the control device 120 is further connected to an output of a current measuring device 124, which is configured to measure the current flowing through the electric motor 110. The current measuring device 124 can be designed, for example, as a component of a controller for regulating a speed of the elevator car 104 and/or as a component of a converter. Contrary to the illustration selected in FIG. 1, the current measuring device 124 can also be designed as a component of the control device 120.

The control device 120 is configured to control the electric motor 110 in such a way that the elevator car 104 performs a series of test runs between the two positions 112, 114 within the scope of a method described in more detail below. In some of the test runs, the elevator car 104 can be loaded with a weight 126, as shown in FIG. 1.

The individual steps of the method described below for determining a lead torque are illustrated in the flow chart shown in FIG. 4.

According to the example shown in FIG. 2, in a first step S10 (FIG. 4) the control device 120 generates control commands 200, which prompt the electric motor 110 to raise or lower the elevator car 104 so that the elevator car 104 performs a first, second, third, and fourth test run. The test runs can be successively carried out in the sequence indicated. However, another suitable sequence of test runs is also possible. In this case, the elevator car 104 is moved in the first and third test runs from the first position 112 to the second position 114 and in the second and fourth test runs from the second position 114 to the first position 112. In addition, the elevator car 104 is loaded with the weight 126 before the third test run so that the elevator car 104 carries out the third and fourth test runs with the weight 126. In the first and second test runs, however, the elevator car 104 is not loaded.

In each of the aforementioned test runs, in a second step S20 (FIG. 4), current measurement data 202, which are generated and provided by the current measuring device 124 in a plurality of successive time steps during the movement of the elevator car 104 and height measurement data 204, which are generated and provided by the height measuring device 122 in a plurality of successive time steps during the movement of the elevator car 104, are received in the control device 120 in a plurality of successive time steps.

The current measurement data 202 and the height measurement data 204 are processed in a third step S30 (FIG. 4) to obtain at least one calibration value 206 that is associated with a parameter 208 of a calibration function 210 that defines a linear relationship between the current flowing through the electric motor 110, the height of the elevator car 104 and a mass of the weight 126.

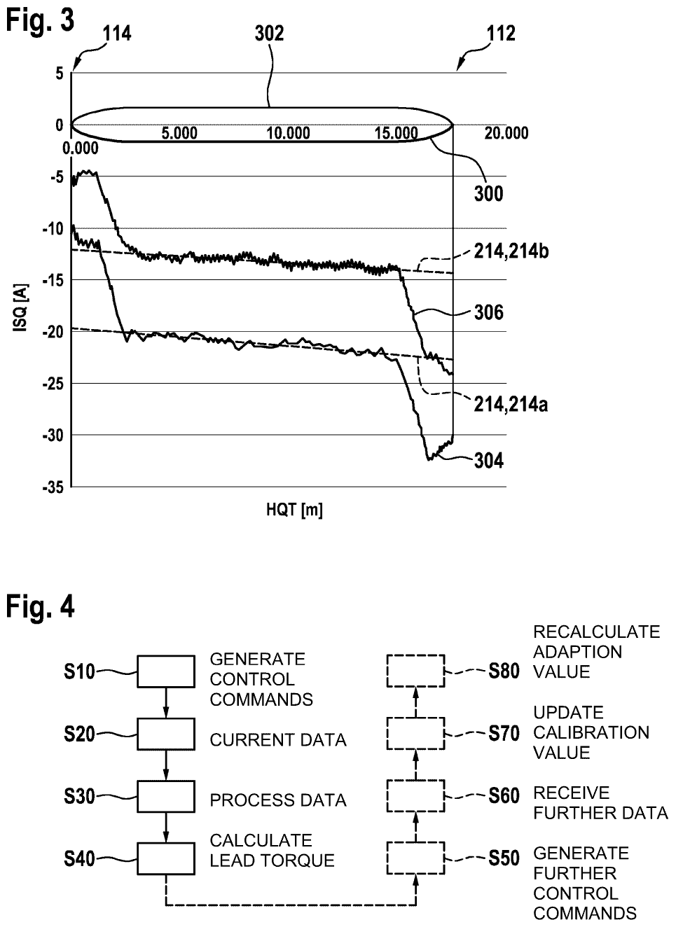

For this purpose, the current measurement data 202 and the height measurement data 204 are input into a first module 212, which determines an output function 214, which defines a linear relationship between the current and the height, for each test run on the basis of the current measurement data 202 and the height measurement data 204 received in different time steps in the relevant test run (see also FIG. 3).

Each output function 214 comprises in this case a first parameter 216 relating to the height and a second parameter 218.

In a second module 220, a first average function 222 and a second average function 224 are determined by correspondingly combining the four output functions 214 obtained, which are likewise linear functions each having a further first height-related parameter 226 and a further second parameter 228.

The further first parameter 226 for the first average function 222 is calculated by forming a mean value from the first parameters 216 of the two output functions 214, which result from the first and second test runs. The further second parameter 228 for the first average function 222 is calculated by forming a mean value from the second parameters 218 of the two output functions 214, which result from the first and second test runs.

By contrast, the further first parameter 226 for the second average function 224 is calculated by forming a mean value from the first parameters 216 of the two output functions 214 resulting from the third and fourth test runs. Similarly, the further second parameter 228 for the second average function 224 is calculated by forming a mean value from the second parameters 218 of the two output functions 214 resulting from the third and fourth test runs.

The second module 220 is further configured to calculate a first current value 232 by inputting a height reference value 230 into the first average function 222 and to calculate a second current value 234 by inputting the height reference value 230 into the second average function 224.

The height reference value 230 was calculated, for example, by halving a height difference between the first position 112 and the second position 114 measured during a previous programming run. However, other methods for calculating the height reference value 230 are also possible.

The calibration value 206 is calculated in a third module 236.

In this example, the third module 236 calculates a height-related parameter 208a of the calibration function 210 to obtain a height calibration value 206a, a weight-related parameter 208b of the calibration function 210 to obtain a weight calibration value 206b, and a current-related parameter 208c of the calibration function 210 to obtain a current calibration value 206c.

The height calibration value 206a is calculated, for example, by forming a mean value from the two further first parameters 226 of the first average function 222 and the second average function 224.

The weight calibration value 206b is calculated, for example, from the two current values 232, 234 and a weight value 238 indicating the mass of the weight 126 by the first current value 232 being subtracted from the second current value 234 and the resulting difference being divided by the weight value 238.

The current calibration value 206c is calculated, for example, from the height calibration value 206a, the height reference value 230 and the first current value 232 by the height calibration value 206a being multiplied by the height reference value 230 and the resulting product being subtracted from the first current value 232.

Finally, in a fourth step S40 (FIG. 4), in a fourth module 240 using the calibration value 206 or the calibration values 206a, 206b, 206c, a lead torque 242 is calculated, which indicates the torque that must be applied to the electric motor 110 in order to prevent the elevator car from moving when the elevator car brake is released.

For this purpose, for example, a negative actual equilibrium factor 246 is calculated in a first block 244 by the height calibration value 206a being multiplied by the height reference value 230, the resulting product being added to the current calibration value 206c, and the resulting sum being divided by the weight calibration value 206b and the permissible mass of the weight (126, not shown).

Subsequently, for example, in a second block 248, the lead torque 242 is calculated by adding the negative actual equilibrium factor 246 multiplied by the permissible mass of the weight (126) to a value 250.

In this case, the value 250 corresponds, for example, to a sum of the second weight difference (unbalance_bot); the current mass of the weight (126) in the elevator car, and the measured height divided by the height difference between the first position (112) and the second position (114) multiplied by the difference between the first weight difference (unbalance_top) minus the second weight difference (unbalance_bot).

The control device 120 can be configured to generate further control commands 252 after the initial calculation of the calibration value 206 or the calibration values 206a, 206b, 206c, in an optional step S50 (FIG. 4), for example on the occasion of a regular inspection, by which the electric motor 110 is controlled in such a way that the elevator car 104 performs further test runs, wherein the elevator car 104 is moved from the first position 112 to the second position 114 and in the opposite direction in these further test runs, for example.

Analogously to step S20 described above, in an optional step S60 (FIG. 4), the control device 120 receives further current measurement data 254 from the current measuring device 124 and further height measurement data 256 from the height measuring device 122 in a plurality of successive time steps in the further test runs.

The further measurement data 254, 256 are used in an optional step S70 (FIG. 4) by the control device 120 to update at least one of the calibration values 206, 206a, 206b, 206c. The further measurement data 254, 256 can be processed in a similar way to that described above with reference to step S30. For example, in this case only the current calibration value 206c may be updated, while the height calibration value 206a and the weight calibration value 206b remain unchanged.

The adaptation value 242 is then recalculated in an optional step S80 (FIG. 4) by processing the updated calibration value or values together with the non-updated calibration value or values.

FIG. 3 shows, by way of example, in each case as a function of the measured height HQT of the elevator car 104, a first speed profile 300, which indicates the speed of the elevator car 104 in [m/s] during the first test run, a second speed profile 302, which indicates the speed of the elevator car 104 in [m/s] during the second test run, a first current profile 304 of the measured current ISQ that is assigned to the first speed profile 300, and a second current profile 306 of the measured current ISQ that is assigned to the second speed profile 302. In addition, the output functions 214 resulting from the first and second test runs, specifically a first output function 214a resulting from the first test run and a second output function 214b resulting from the second test run, are plotted.

A constant portion of the speed curves 300, 302 corresponds to a height range within which the speed of the elevator car 104 is or is detected as constant. The height range (HQ_const_speed) is calculated, for example, from the height difference (HQ) between the two positions 112, 114, a nominal speed (VKN), a nominal acceleration (AK) and a nominal pressure (JK) of the elevator car 104 as follows:

$$HQ\_const \_speed = HQ - \frac{V K {N}^{2}}{A K} - \frac{VKN \cdot AK}{JK} + \frac{A {K}^{2}}{{JK}^{2}} .$$

If HQ_const_speed≥60%*HQ, then a test speed (v4) at which the elevator car 104 is to be moved during the test runs is set to be equal to the nominal speed. Otherwise, the test speed is calculated, for example, where:

$$v 4 = \frac{A {K}^{2}}{2 \cdot JK} \cdot \{ \sqrt{5 + \frac{4 \cdot ( 1 - 0.6 ) \cdot HQ \cdot {JK}^{2}}{A {K}^{3}}} - 1 \} ,$$

so that HQ_const_speed=60%*HQ.

FIG. 3 shows typical results for HQ_const_speed≥60%*HQ.

An example of how to determine the lead torque is described below. GQT stands for the current mass of the weight 126 in [kg]. Accordingly, the following applies: GQT=0 kg when the elevator car 104 is unloaded; GQT=GQ if the current mass of the weight 126 is equal to the permissible mass GQ of the weight 126. Furthermore, the following applies: HQT=0 m when the elevator car 104 is in the second position 114, i.e. in the lowermost story; HQT=HQ when the elevator car 104 is in the first position 112, i.e. in the uppermost story.

First, the weight value 238 is input via a user interface, i.e. GQT_test1=0 for the first and second test runs, and for the third and fourth test runs, for example, GQT_test2=GQ or GQT_test2≈GQ.

Thereupon, the control device 120 requests a current converter current iq from the converter, which current is regularly communicated to the control device 120 at certain time intervals, for example every 10 ms, during the remaining course of the method.

The test run then starts according to the selected test speed.

As soon as it is identified that the elevator car 104 is moving within the height range HQ_const_speed, a linear regression is started based on the current measurement data 202 or 254 and the height measurement data 204 or 256, wherein the results of the linear regression are updated in each time step, i.e. for example every 10 ms.

As soon as it is detected that the elevator car 104 is no longer moving within the height range HQ_const_speed, the linear regression is aborted.

From the regression results obtained up to the time of the interruption, the first parameter 216 and the second parameter 218 of the relevant output function 214 are calculated at the end of the test run.

The following four output functions 214 result from the first through fourth test runs:
for the first test run:

$$ISQ\_test1 \_down ( HQT , GQT = GQT\_test1 ) = a\_test1 \_down * HQT + b\_test1 \_down ;$$

for the second test run:

$$ISQ\_test1 \_up ( HQT , GQT = GQT\_test1 ) = a\_test1 \_up * HQT + b\_test1 \_up ;$$

for the third test run:

$$ISQ\_test2 \_down ( HQT , GQT = GQT\_test2 ) = a\_test2 \_down * HQT + b\_test2 \_down ;$$

for the fourth test run:

$$ISQ\_test2 \_up ( HQT , GQT = GQT\_test1 ) = a\_test2 \_up * HQT + b\_test2 \_up .$$

Here, a_test1_down, a_test1_up, a_test2_down and a_test2_up each denote the first parameter 216 and b_test1_down, b_test1_up, b_test2_down and b_test2_up each denote the second parameter 218 of the relevant output function 214.

From these results, the control device 120 calculates the three calibration values a_HQT, b_GQT, and ISQ0 and permanently stores them. In this case, a_HQT denotes the height calibration value 206a, b_GQT denotes the weight calibration value 206b, and ISQ0 denotes the current calibration value 206c.

It is assumed here that the same, i.e. ideal, frictional conditions apply for both directions of movement of the elevator car 104. Under this assumption, the current, more precisely a q component of the current (ISQ_no_friction) used for controlling a torque of the electric motor 110, can be calculated as follows:
with the aid of the first average function 222:

$$ISQ\_no \_friction \_test1 ( HQT , GQT = GQT\_test1 ) = a\_test1 * HQT + b\_test1 ;$$

with the aid of the second average function 224:

$$ISQ\_no \_friction \_test2 ( HQT , GQT = GQT\_test2 ) = a\_test2 * HQT + b\_test2 .$$

The following applies:

$$a\_test1 = ( a\_test1 \_down + a\_test1 \_up ) / 2 ;$$

$$b\_test1 = ( b\_test1 \_down + b\_test1 \_up ) / 2 ;$$

$$a\_test2 = ( a\_test2 \_down + a\_test2 \_up ) / 2 ;$$

$$b\_test2 = ( b\_test2 \_down + b\_test2 \_up ) / 2.$$

Here, a_test1 and a_test2 denote the further first parameters 226, and b_test1 and b_test2 denote the further second parameters 228.

a_test1 and a_test2 are ideally identical and depend only on HQT, while b_test1 and b_test2 are not dependent on HQT, but instead only on GQT.

The calibration function 210 accordingly reads as:

$$ISQ\_no \_friction = a\_HQT * HQT + b\_GQT * GQT + ISQ 0 ,$$

with a_HQT in [A/m], b_GQT in [A/kg] and ISQ0 in [A].

a_HQT is independent of GQT. Because a_test1 and a_test2 are based on mutually independent measurements, a_HQT can easily be calculated with:

$$a\_HQT = ( a\_test1 + a\_test2 ) / 2.$$

b_HQT and ISQ0 can be calculated with the following equation system:

$$ISQ\_no \_friction \_test1 ( HQT = HQ / 2 , GQT = GQT\_test1 ) = a\_HQT * HQ / 2 + b\_GQT * GQT\_test1 + ISQ 0 ;$$

$$ISQ\_no \_friction \_test2 ( HQT = HQ / 2 , GQT = GQT\_test2 ) = a\_HQT * HQ / 2 + b\_GQT * GQT\_test2 + ISQ 0.$$

b_GQT yields:

$$b\_GQT = [ ISQ\_no \_friction \_test2 ( HQT = HQ / 2 , GQT = GQT\_test2 ) - ISQ\_no \_friction \_test1 ( HQT = HQ / 2 , GQT = GQT\_test1 ) ] / \\ [ GQT\_test2 - GQT\_test1 ] .$$

ISQ0 yields:

$$ISQ 0 = ISQ\_no \_friction \_test1 ( HQT = HQ / 2 , GQT = GQT\_test1 ) - a\_HQT * HQ / 2 - b\_GQT * GQT\_test1 .$$

The values a_HQT, b_GQT and ISQ0 are permanently stored in memory.

For the calculations described below, the following applies:

KG_act: present compensation factor (0<KG_act<1).

The elevator system 100 can be assumed to be balanced if the following applies:

$$ISQ\_no \_friction ( HQT = HQ / 2 , GQT ) = 0.$$

From this:

$$ISQ\_no \_friction ( HQT = HQ / 2 , GQT ) = a\_HQT * HQ / 2 + b\_GQT * GQT\_balanced + ISQ 0 = 0 ;$$

$$GQT\_balanced = - [ a\_HQT * HQ / 2 + ISQ 0 ] / b\_GQT$$

The existing compensation factor is calculated as follows:

$$KG\_act = GQT\_balanced / GQ = - 100 * [ a\_HQT * HQ / 2 + ISQ 0 ] / b\_GQT / GQ .$$

From the relationship ISQ_no_friction (HQT, GQT)=a_HQT*HQT+b_GQT*GQT+ISQ0
the weight difference can be defined as

unbalance (HQT,GQT)=ISO_no_friction(HQT,GQT)/b_GQT.

The first weight difference is the additionally required weight for compensating the load at the first position (uppermost floor), wherein such a weight difference arises by inappropriate balancing of the system and/or by the suspension means. The first weight difference is

$$unbalance\_top [ kg ] = unbalance ( HQT = HQ , GQT ) - unbalance ( HQT = HQ / 2 , GQT ) = + ISQ\_no \_friction ( HQT = HQ , GQT ) / b\_GQT$$

$$ISQ\_no \_friction ( HQT = HQ / 2 , GQT ) / b\_GQT = + ( a\_HQT * HQ + b\_GQT * GQT + ISQ 0 ) / b\_GQT$$

$$( a\_HQT * HQ / 2 + b\_GQT * GQT + ISQ 0 ) / b\_GQT = + ( a\_HQT * HQ - a\_HQT * HQ / 2 ) / b\_GQT$$

unbalance_bot=+a_HQT/b_GQT*HQ/2,

wherein this is independent of GQT.

The second weight difference is the additionally required weight for compensating the load at the second position (lowest floor), wherein such a weight difference arises by an incorrect compensation of the system and/or by the suspension means. The second weight difference is

$$unbalance\_bot [ kg ] = unbalance ( HQT = 0 , GQT ) - unbalance ( HQT = HQ / 2 , GQT ) = + ISQ\_no \_friction ( HQT = 0 , GQT ) / b\_GQT$$

$$ISQ\_no \_friction ( HQT = HQ / 2 , GQT ) / b\_GQT = + ( a\_HQT * 0 + b\_GQT * GQT + ISQ 0 ) / b\_GQT$$

$$( a\_HQT * HQ / 2 + b\_GQT * GQT + ISQ 0 ) / b\_GQT = + ( a\_HQT * 0 - a\_HQT * HQ / 2 ) / b\_GQT$$

Unbalance_top=−a_HQT/b_GQT*HQ/2,

wherein this is independent of GQT.

The elevator controller sends the value “load” (unit=[kg]) to the frequency converter. The frequency converter calculates the value of the lead torque as a proportional factor from the “load” value.

The value “load” is calculated by the elevator control as follows:

$$load [ kg ] = GQT - KG\_act * GQ + HQT / HQ * [ unbalance\_top - unbalance\_bot ] + unbalance\_bot .$$

Finally, it should be noted that terms such as “comprising,” “having,” etc., do not exclude other elements or steps, and terms such as “a” or “an” do not exclude a plurality. Furthermore, it should be noted that features or steps that have been described with reference to one of the above embodiments can also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-16. (canceled)

17. A method for determining a lead torque of an elevator system, the elevator system including an elevator shaft, an elevator car movable along the elevator shaft between a first position and a second position, the elevator car being coupled to a counterweight via suspension means, and an electric motor with a traction sheave that drives the suspension means thereby moving the elevator car and the counterweight in the elevator shaft, the method comprising the steps of:
generating control commands that control the electric motor such that the elevator car performs a first test run, a second test run, a third test run and a fourth test run;
wherein the elevator car moves from the first position to the second position during each of the first test run and the third test run and the elevator car moves from the second position to the first position during each of the second test run and the fourth test run;
wherein the elevator car is loaded with a predetermined weight during the third test run and the fourth test run and is not loaded with the weight during the first test run and second test run;
receiving current measurement data indicating an electric current that flows through the electric motor and is measured by a current measuring device during the movement of the elevator car in each of the test runs, and receiving height measurement data indicating a height of the elevator car relative to the first position and/or second position and measured by a height measuring device in a plurality of successive time steps during the movement of the elevator car in each of the test runs;
calculating at least one parameter of a calibration function that defines a relationship between the current, the height and the weight, using the current measurement data and the height measurement data received during the test runs, to obtain at least one calibration value;
calculating a first weight difference representative of a weight difference between a first mass of the elevator system on one side of the traction sheave of the electric motor and a second mass of the elevator system on an opposite side of the traction sheave when the elevator car is in the first position;
calculating a second weight difference representative of a weight difference between a third mass of the elevator system on the one side of the traction sheave and a fourth mass of the elevator system on the opposite side of the traction sheave when the elevator car is in the second position;
calculating the first weight difference and the second weight difference using the calibration function and the at least one calibration value; and
determining a lead torque for applying to the electric motor before the elevator car is moved in response to the first weight difference and the second weight difference.

18. The method according to claim 17 including calculating a height reference value by halving a height difference between the first position and the second position, and/or calculating a weight reference value by multiplying a permitted mass of the weight by a predetermined weighting factor.

19. The method according to claim 18 including:
determining a first average function that defines a first relationship between the current and the height, while assuming ideal frictional conditions, using the current measurement data and the height measurement data received during the first test run and second test run; and/or
determining a second average function that defines a second relationship between the current and the height, while assuming ideal frictional conditions, using the current measurement data and the height measurement data received during the third test run and fourth test run; and
calculating the at least one parameter of the calibration function using the first average function and/or the second average function.

20. The method according to claim 19 including:
determining, for each of the test runs, an output function defining a linear relationship between the current and the height by processing the current measurement data and the height measurement data that were received in different time steps during the test run;
calculating at least one parameter of the first average function by forming a mean value from a parameter of the output function for the first test run and a parameter of the output function for the second test run; and/or
calculating at least one parameter of the second average function by forming a mean value from a parameter of the output function for the third test run and a parameter of the output function for the fourth test run.

21. The method according to claim 20 including:
calculating a first current value by inputting a height reference value into the first average function, and/or calculating a second current value by inputting the height reference value into the second average function; and
calculating the at least one parameter of the calibration function using the first current value and/or the second current value.

22. The method according to claim 21 including calculating a height-related parameter of the calibration function to obtain a height calibration value as the at least one calibration value, and/or calculating a parameter of the calibration function relating to the weight to obtain a weight calibration value as the at least one calibration value and/or calculating a current-related parameter of the calibration function to obtain a current calibration value as the at least one calibration value.

23. The method according to claim 22 including obtaining the height calibration value by forming a mean value from a height-related parameter of the first average function and a height-related parameter of the second average function.

24. The method according to claim 22 including:
obtaining the weight calibration value by dividing a difference between the first current value and the second current value by a weight value indicating a current mass of the weight; and/or
obtaining the current calibration value by subtracting a product of the height calibration value and the height reference value from the first current value and/or subtracting the product from the weight calibration value multiplied by a mass of the actual weight at the first test run.

25. The method according to claim 22 including wherein, in each of the time steps, checking whether the elevator car is moving at a constant speed and for calculating the at least one parameter of the calibration function, using only the current measurement data and/or only the height measurement data from the time steps in which the elevator car is identified as moving at the constant speed.

26. The method according to claim 22 including multiplying the height calibration value by the height reference value to obtain a product, adding the product to the current calibration value to obtain a sum, and dividing the sum by the weight calibration value and the permissible mass of the weight to obtain a negative actual balance factor.

27. The method according to claim 26 including determining the first weight difference and/or the second weight difference based upon the calibration function and the weight calibration value, wherein the first weight difference is determined from the negative height calibration value divided by the weight calibration value multiplied by the height reference value, and wherein the second weight difference is determined from the height calibration value divided by the weight calibration value multiplied by the height reference value.

28. The method according to claim 27 including wherein the lead torque is proportional to a sum of the second weight difference, the current mass of the weight in the elevator car, the negative actual equilibrium factor multiplied by the permissible mass of the weight, and the measured height divided by the height difference between the first position and the second position multiplied by a difference of the first weight difference minus the second weight difference.

29. A control device for an elevator system, the elevator system including an elevator shaft, an elevator car movable along the elevator shaft between a first position and a second position, the elevator car being coupled to a counterweight via suspension means, and an electric motor with a traction sheave that drives the suspension means thereby moving the elevator car and the counterweight in the elevator shaft, the control device comprising a processor adapted to carry out the method according to claim 17 and apply the lead torque to the electric motor.

30. An elevator system (100), comprising:
the control device according to claim 29;
an elevator shaft;
an elevator car movable along the elevator shaft between a first position and a second position;
a counterweight coupled to the elevator car via a suspension means;
an electric motor driving the elevator car via the suspension means;
a current measuring device measuring an electric current flowing through the electric motor; and
a height measuring device measuring a height of the elevator car relative to the first position and/or the second position.

31. A computer program comprising non-transitory commands that cause the elevator system to carry out the method according to claim 17 when the commands are executed by a computer processor.

32. A non-transitory computer-readable medium on which the computer program according to claim 31 is stored.
